(19) United States
(12) Patent Application Publication
(10) Pub. No.: US 2014/0316748 A1
(43) Pub. Date: Oct. 23, 2014

(54) Posture Guided Design Of Deformable Objects

(71) Applicants: ETH Zurich, Zurich (CH); Disney Enterprises, Inc., Burbank, CA (US)

(72) Inventors: Bernd Bickel, Zurich (CH); Melina Skouras, Zurich (CH); Bernhard Thomaszewski, Zurich (CH); Stelian Coros, Zurich (CH); Markus Gross, Zurich (CH)

(73) Assignees: ETH Zurich, Zurich (CH); Disney Enterprises, Inc., Burbank, CA (US)

(21) Appl. No.: 14/023,808

(22) Filed: Sep. 11, 2013

Related U.S. Application Data
(60) Provisional application No. 61/815,174, filed on Apr. 23, 2013.

(51) Int. Cl. G06F 17/50

(52) U.S. Cl. CPC G06F 17/50
USPC 703/1

(57) ABSTRACT

There is provided a posture guided design system and a method for use in producing a posture guided design of a deformable object. In one implementation, such a method includes identifying a target posture for the deformable object, and determining locations of actuators for producing the target posture. The method also includes modeling the deformable object using at least one material so as to enable the deformable object to substantially reproduce the target posture. In some implementations, the method includes modeling the deformable object using at least two materials, wherein a distribution of the at least two materials is determined so as to enable the deformable object to substantially reproduce the target posture.

The present application claims the benefit of and priority to a pending provisional application entitled “Computational Design of Actuated Deformable Characters,” Ser. No. 61/815,174 filed on Apr. 23, 2013. The disclosure in this pending provisional application is hereby incorporated fully by reference into the present application.

### BACKGROUND

### Background Art

Computer generated virtual characters having rich visual features and capable of a wide range of complex movements play an increasingly important role in the production of entertainment content. Some of these virtual characters may be rigidly articulated, while others are capable of substantial deformation. Still others display both properties to some degree, ranging for example from humanoid virtual characters having exaggerated physical features to fantastic monsters and background features like virtual plants or virtual depictions of man-made objects.

As the role of virtual characters grows in importance, so does their popularity with the consumers of entertainment content. As a result, it is sometimes desirable to replicate virtual characters as physical objects, such as mechanical or deformable objects, for example. Although significant efforts have been directed to the design and production of mechanical characters, such as animatronic characters for example, relatively little progress has been made in the design and production of deformable characters. Moreover, conventional approaches to creating deformable objects typically require the participation of expert designers and engineers, and remain largely processes of trial and error, often requiring many iterations to produce an acceptable product. One unfortunate result of the costs associated with such an expertise intensive iterative design approach is that public access to and enjoyment of deformable objects such as deformable characters may be undesirably limited.

### SUMMARY

There are provided systems and methods for performing posture guided design of deformable objects, substantially as shown in and/or described in connection with at least one of the figures, and as set forth more completely in the claims.

### BRIEF DESCRIPTION OF THE DRAWINGS

FIG. 1 shows a diagram of an exemplary design system configured to produce a posture guided design of a deformable object, according to one implementation;

FIG. 2 shows another exemplary implementation of a design system configured to produce a posture guided design of a deformable object;

FIG. 3 shows an exemplary design terminal and a computer-readable medium including instructions enabling production of a posture guided design of a deformable object, according to one implementation;

FIG. 4 is a flowchart presenting an exemplary method for use by a design system to produce a posture guided design of a deformable object; and

FIG. 5 shows an exemplary representation of a deformable object at various stages of a posture guided design process, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As explained above, conventional approaches to creating deformable objects typically require the participation of expert designers and engineers, and remain largely processes of trial and error, often requiring many iterations to produce an acceptable product. As further noted above, one unfortunate result of the costs associated with conventional approaches to designing deformable objects is that public access to and enjoyment of those deformable objects, such as deformable characters, may be undesirably limited. The present application discloses an improved design solution that adopts a posture guided computational design approach for producing deformable objects capable of relatively complex and sophisticated movements or poses. Moreover, some implementations of the present solution may enable a substantially non-expert user, such as a lay person or consumer, to design deformable objects capable of assuming a wide range of postures.

As used in the present application, the expression “deformable object” can refer to any physical object configured to assume one or more predetermined postures or poses. In some implementations, a deformable object may take the form of a deformable character representative of an animated being, such as a humanoid character, an animal character, or a fantasy life form character, for example. In other implementations, a deformable object may correspond to an inanimate object, such as a building or candelabra, for example. In yet other implementations, a deformable object may correspond to a hybrid character having both animated and inanimate features.

As noted above, the present posture guided design solution may be utilized by non-expert users as well as expert designers and engineers. When utilized by expert designers and engineers, for example, the present posture guided design solution may be used to produce large, complex, deformable objects including deformable characters encountered in a theme park or other recreational or entertainment venue. When utilized by non-expert users, such as a theme park visitor or other type of consumer, for example, the present posture guided design solution may be used to produce smaller deformable objects, such as consumer products or commemorative items that the non-expert user may purchase or otherwise acquire. Examples of consumer products provided by deformable objects include action figures and puppets.

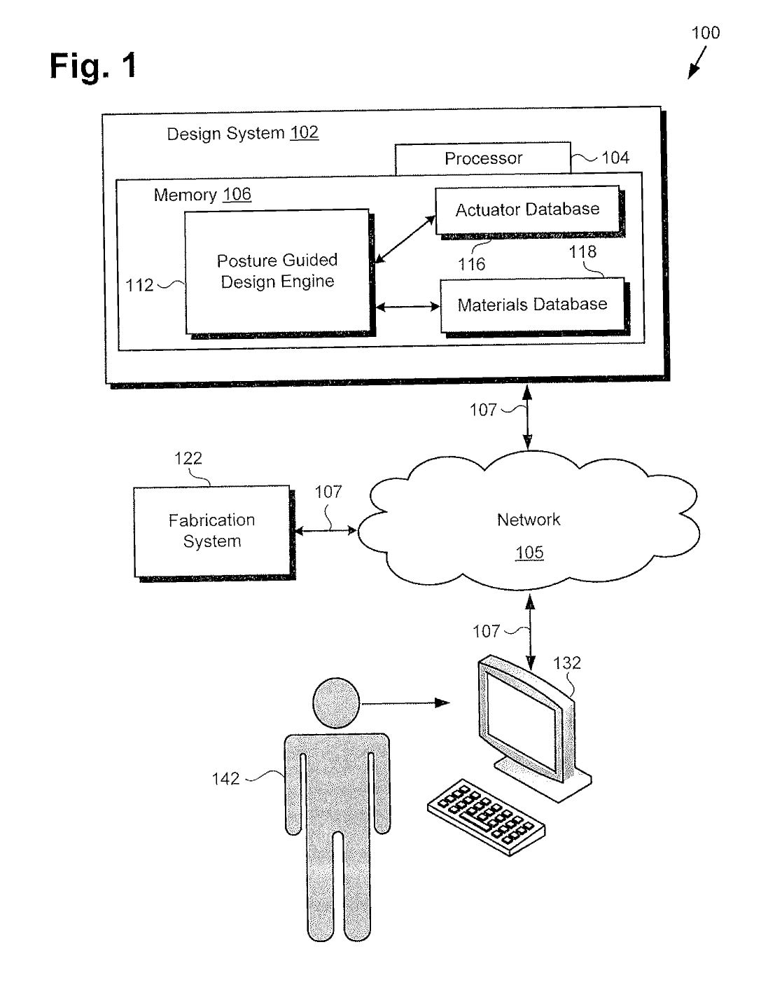

FIG. 1 shows a diagram of a design system configured to produce a posture guided design of a deformable object, according to one implementation. As shown in FIG. 1, design environment 100 includes design system 102, communications network 105, fabrication system 122, which may be a multi-material fabrication system for example, design terminal 132, and consumer or user 142 utilizing design terminal 132 (hereinafter “designer 142”). As further shown in FIG. 1, design system 102 includes design system processor 104, and design system memory 106 storing actuator database 116, materials database, and posture guided design engine 112. Also shown in FIG. 1 are network communication links 107 interactively connecting design terminal 132, fabrication system 122, and design system 102 via communications network 105.

It is noted that although FIG. 1 depicts actuator database 116, materials database, and posture guided design engine 112 as being mutually co-located in design system memory 106, that representation is merely provided as an aid to conceptual clarity. More generally, design system 102 may include one or more design servers, which may be co-located, or may form an interactively linked but distributed system. As a result, design system processor 104 and design system memory 106 may correspond to distributed processor and memory resources within design system 102. Thus, it is to be understood that actuator database 116, materials database 118, and posture guided design engine 112 may be stored remotely from on another within the distributed memory resources of design system 102, which may be a cloud based system, for example.

It is further noted that in some implementations, design system 102 may not include actuator database 116 and/or materials database 118. In those implementations, actuator database 116 and/or materials database 118 may be external resources for design system 102, such as third party resources, for example, accessible over communications network 105. Moreover, in some implementations, design system 102 may include fabrication system 122, which may include a single-material or multi-material three-dimensional (3D) printer, for example, configured to fabricate a deformable object based on a posture guided design produced by posture guided design engine 112.

According to the implementation shown by FIG. 1, designer 142 may utilize design terminal 132 to interact with posture guided design engine 112 of design system 102, over communications network 105. In one such implementation, design system 102 may correspond to one or more web servers, accessible over a packet network such as the Internet, for example. Alternatively, design system 102 may correspond to one or more design servers supporting a local area network (LAN), or included in another type of limited distribution network.

Although design terminal 132 is shown as a personal computer (PC) in FIG. 1, that representation is also provided merely as an example. In other implementations, design terminal 132 may be another type of mobile or stationary computing device or system. For example, design terminal 132 may take the form of a design kiosk in a theme park environment, or may be implemented as a tablet computer, or a mobile communication device such as a smartphone, for example.

As shown in FIG. 1, posture guided design engine 112, under the control of design system processor 104, may receive one or more inputs from designer 142 over communications network 105. For example, and as will be described in greater detail below, posture guided design engine 112 may receive inputs enabling identification of a deformable object and/or one or more target postures of the deformable object.

Posture guided design engine 112 may be configured to determine locations of actuators for producing the target postures, the actuators being stored in actuator database 116. In addition, or alternatively, posture guided design engine 112 may be configured to utilize materials database 118 to model the deformable object using one, or two or more materials, so as to enable the deformable object to substantially reproduce the target posture or postures. For example, posture guided design engine 112 may model the deformable object using two or more materials of which one or more may be relatively easily deformable and one or more may be relatively deformation resistant. When two or more materials are utilized to model the deformable object, posture guided design engine 112 may be further configured to determine a distribution of the two or more materials so as to enable the deformable object to substantially reproduce the target posture or postures. When a satisfactory posture guided design of the deformable object is produced, design system 102 may send the posture guided design to fabrication system 122 for fabrication of the deformable object.

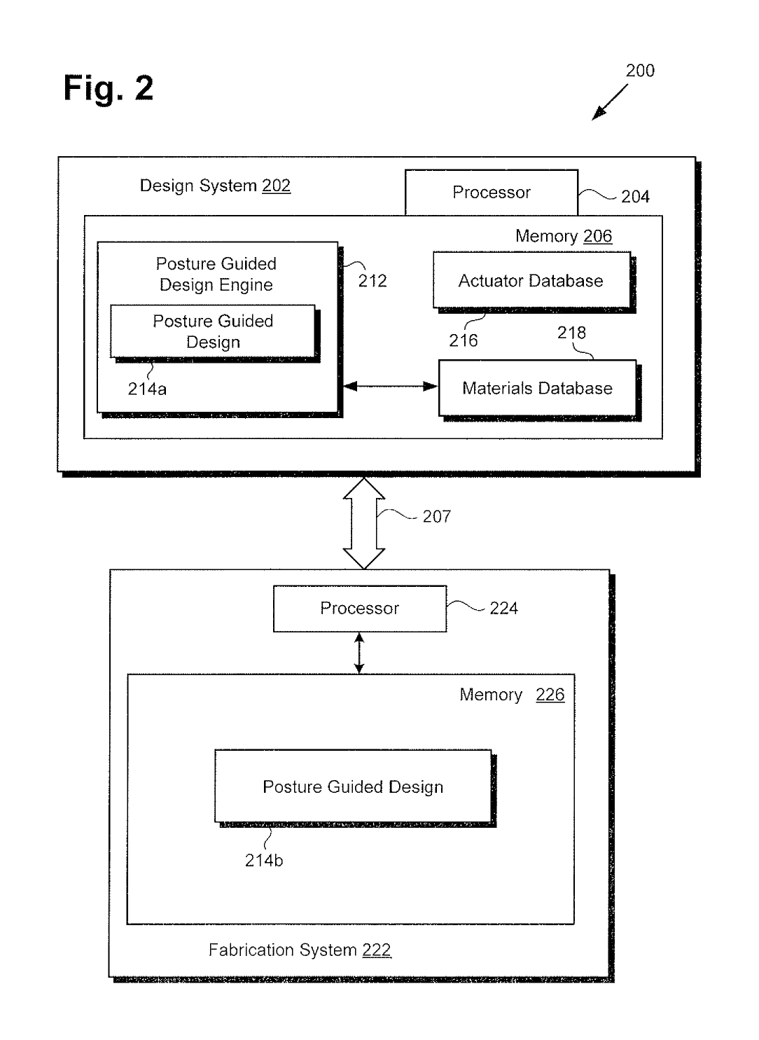

Referring to FIG. 2, FIG. 2 shows another exemplary implementation of a design system configured to produce a posture guided design of a deformable object. Design environment 200 includes design system 202 in communication with fabrication system 222 over network communication link 207. Design system 202 is shown to include design system processor 204, and design system memory 206 storing actuator database 216, materials database 218, and posture guided design engine 212. Also shown in FIG. 2 are posture guided design 214a produced by posture guided design engine 212 and residing in design system memory 206.

Design system 202 including design system processor 204 and design system memory 206 corresponds to design system 102 including design system processor 104 and design system memory 106, in FIG. 1. Moreover, actuator database 216, materials database 218, and posture guided design engine 212 producing posture guided design 214a, in FIG. 2, correspond respectively to actuator database 116, materials database 118, and posture guided design engine 112, in FIG. 1.

In addition, fabrication system 222 and network communication link 207, in FIG. 2, correspond respectively to fabrication system 122 and any of network communications links 107, in FIG. 1. As shown in FIG. 2, fabrication system 222, which may include a single-material or multi-material 3D printer, for example, includes fabrication system processor 224 and fabrication system memory 226. FIG. 2 also shows posture guided design 214b in fabrication system memory 226. According to the implementation shown in FIG. 2, the presence of posture guided design 214b in fabrication system memory 226 corresponds to its transmission to fabrication system 222 from design system 202 over network communication link 207. It is noted that network communication link 207 is shown as a two-way communication link to represent possible ongoing communication between fabrication system 222 and design system 202.

Fabrication system processor 224 may be the central processing unit for fabrication system 222, for example, in which role fabrication system processor 224 controls the operation of fabrication system 222. Fabrication system processor 224 may further manage use of posture guided design 214b to fabricate the deformable object corresponding to posture guided design 214b. As noted above, in some implementations, fabrication system 222 may be included as a feature of design system 202.

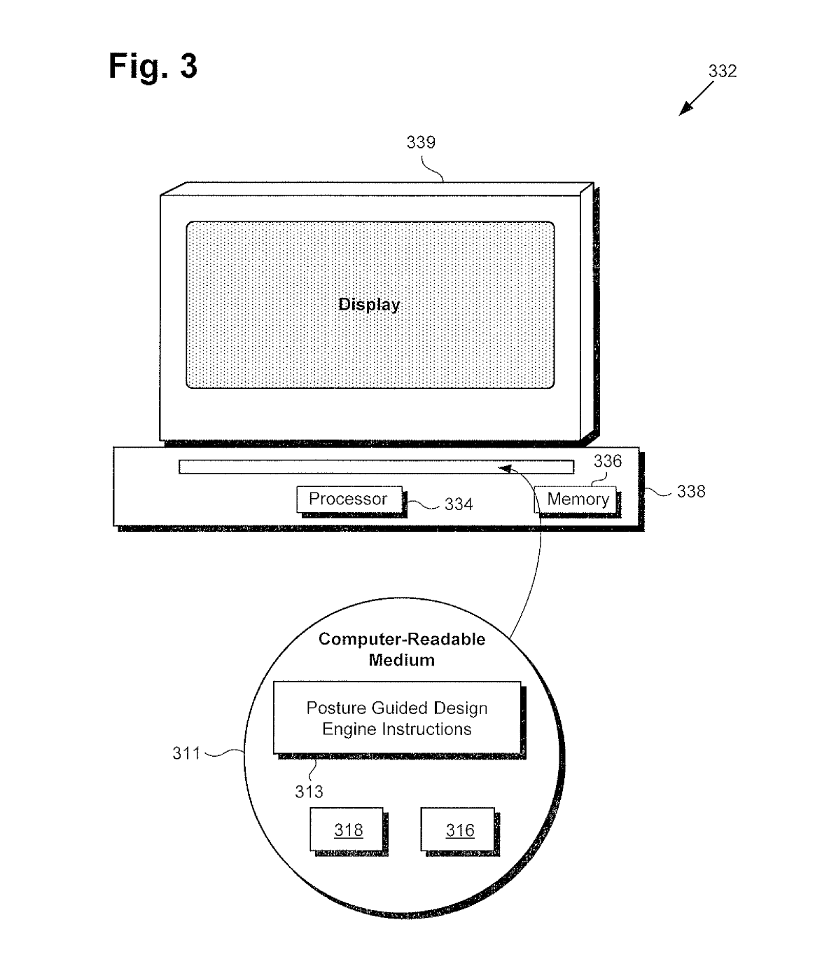

Moving now to FIG. 3, FIG. 3 shows an exemplary design terminal and a computer-readable medium including instructions enabling production of a posture guided design of a deformable object, according to one implementation. Design terminal 332, in FIG. 3, includes computer 338 including processor 334 and memory 336, interactively linked to display 339. Also shown in FIG. 3 is computer-readable medium 311 having actuator database 316, materials database 318, and posture guided design engine instructions 313 stored thereon. Design terminal 332 corresponds to design terminal 132, in FIG. 1.

The expression “computer-readable medium,” as used in the present application, to refers to any non-transitory medium that provides instructions to processor 334 of computer 338. Thus, a computer-readable medium may correspond to various types of non-transitory media, such as volatile media and non-volatile media, for example. Volatile media may include dynamic memory, such as dynamic random access memory (dynamic RAM), while non-volatile memory may include optical, magnetic, or electrostatic storage devices. Common forms of non-transitory computer-readable media include, for example, an optical disc, RAM, programmable read-only memory (PROM), erasable PROM (EPROM), and FLASH memory.

According to the implementation shown by FIG. 3, computer-readable medium 311 provides posture guided design engine instructions 313 for execution by processor 334. Posture guided design engine instructions 313, when executed by processor 334, instantiate a posture guided design engine on design terminal 332 corresponding to posture guided design engine 112, in FIG. 1, and capable of performing all of the operations attributed to posture guided design engine 112 herein. It is noted that although FIG. 3 shows computer-readable medium 311 as including actuator database 316 and materials database 318, that depiction is merely by way of an example. In other implementations, actuator database 316 and/or materials database 318 may not be present on computer-readable medium 311, but may be accessible to design terminal 332 over a communications network corresponding to communications network 105, in FIG. 1.

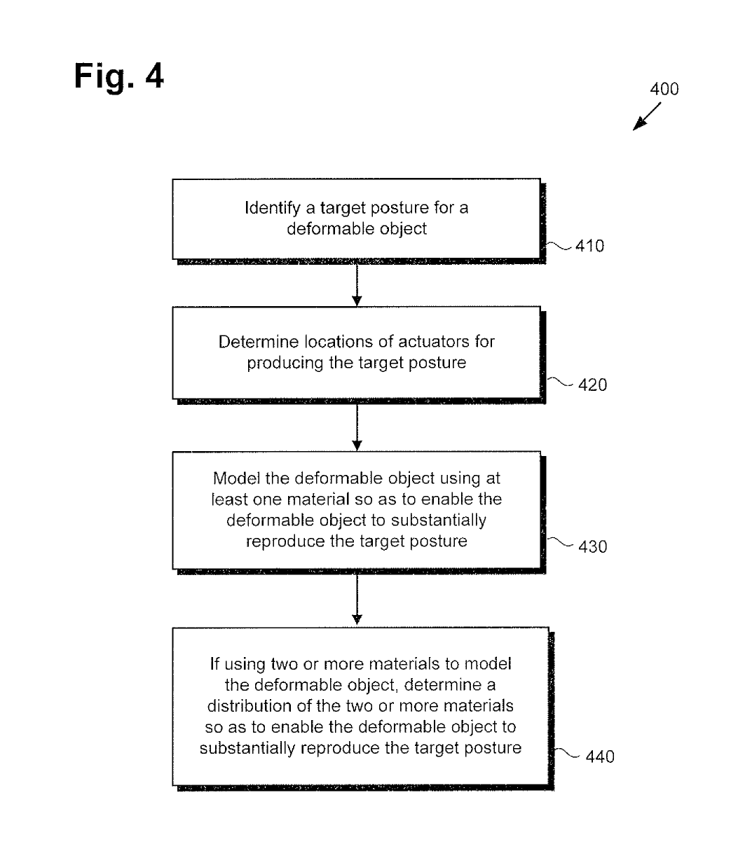

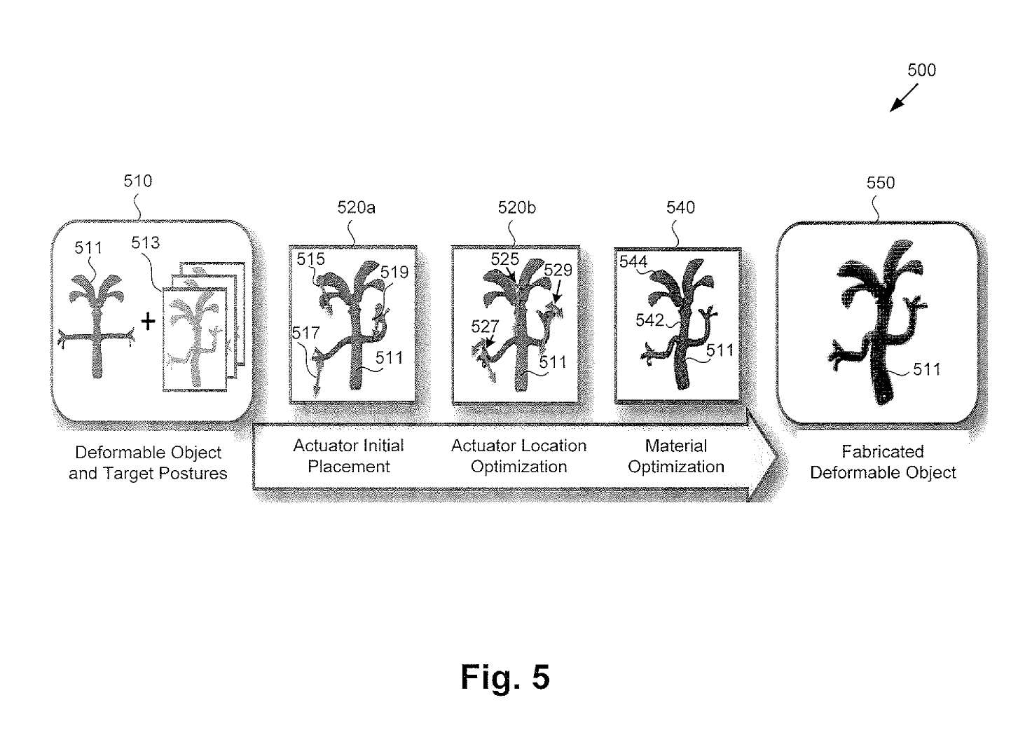

The present inventive concepts will now be further described with reference to FIGS. 4 and 5. FIG. 4 shows a flowchart presenting an exemplary method for use by a design system to produce a posture guided design of a deformable object, while FIG. 5 shows an exemplary representation of a deformable object at various stages of the design process. FIG. 5 shows deformable object 511, depicted as a whimsical animated palm tree, and one or more target postures 513 for deformable object 511. In addition, FIG. 5 shows actuators 515, 517, and 519, and actuator locations 525, 527, and 529 after determination of actuator locations that have been substantially optimized to produce target postures 513. Also shown in FIG. 5 are first and second materials 542 and 544 used to model deformable object 511. With respect to the method outlined in FIG. 4, it is noted that certain details and features have been left out of flowchart 400 in order not to obscure the discussion of the inventive features in the present application.

Referring to FIG. 4 in combination with FIGS. 1 and 5, flowchart 400 begins with identifying a target posture or postures 513 for deformable object 511 (410). As shown by frame 510 in FIG. 5, target postures 513 require deformation of the trunk, limbs, and crown of deformable object 511. According to the design system implementation shown in FIG. 1, target postures 513 can be identified by posture guided design engine 112 of design system 102 based on one or more inputs received by design system 102 over communications network 105. For example, designer 142, who may be a consumer or other novice or non-expert user, may utilize design terminal 132 to provide design inputs to design system 102 enabling posture guided design engine 112 to identify one or more target postures 513. Examples of design inputs received by posture guided design engine 112 may include selection or exemplars of deformable object 511 and/or selection or exemplars of one or more target postures 513.

In some implementations, posture guided design engine 112 may be configured to identify deformable object 511, as well as to identify target posture or postures 513. In those implementations, posture guided design engine may identify deformable object 511 in response to a selection, by designer 142, of deformable object 511 from a catalogue or library of predetermined deformable objects viewable and selectable by designer 142 using design terminal 132. In addition, or alternatively, in some implementations, designer 142 may provide an input exemplar corresponding to a 2D figure or 3D model of deformable object 511 produced by or for designer 142. In those latter implementations, posture guided design engine 112 may be configured to generate data for instantiating deformable object 511 based on the 2D figure or 3D model provided by designer 142.

Posture guided design engine 112 may also be configured to identify one or more target postures 513 based on a selection, by designer 142, of one or more target postures 513 from a catalogue or library of predetermined postures viewable and selectable by designer 142. Moreover, in some implementations, designer 142 may provide exemplars of target posture or postures 513 as one or more inputs to posture guided design engine 112, using design terminal 132 and communications network 105.

Flowchart 400 continues with determining locations 525, 527, and 529 of actuators 515, 517, and 519 for producing target posture or postures 513 (420). As shown by frame 520a deformable object 511 may be deformed, or posed, to assume a posture corresponding to target posture or postures 513 using actuators 515, 517, and 519. Actuators 515, 517, and 519 may be any suitable mechanisms for deforming or posing deformable object 511, such as pins, rods, or strings, for example. As shown in frame 520a, for instance, actuators 515, 517, and 519 may be pin or pressure actuators for exerting respective forces at locations on the surface of deformable object 511 so as to cause deformable object 511 to be deformed. As another specific example, actuators 515, 517, and 519 may be implemented as string actuators configured to attach to locations on the surface of deformable object 511 and to cause deformation of deformable object 511 by pulling on deformable object 511. It is noted that in some implementations, actuators 515, 517, and 519 may include different types of actuators in combination.

Actuators 515, 517, and 519 may be stored in actuator database 116, and may be selected from actuator database 116 and have their initial placement on deformable object 511 performed by posture guided design engine 112. In some implementations, actuators 515, 517, and 519 may be selected and have their initial placement specified based on inputs received by posture guided design engine 112 from designer 142. However, in other implementations, particularly those seeking to enable posture guided design by novice users, or in instances when deformable object 511 has a more amorphous shape lacking a well defined articulation structure, actuators 515, 517, and 519 may be selected and initially placed automatically by posture guided design engine 112. Moreover, in some implementations, the present method may include providing actuator database 116 as part of design system 102.

As shown by frame 520b in FIG. 5, locations 525, 527, and 529 of respective actuators 515, 517, and 519 may be determined so as to be substantially optimized for producing target posture or postures 513. Determination and substantial optimization of locations 525, 527, and 529 may be performed by posture guided design engine 112 computationally, using a continuous optimization process, for example. In addition, in some implementations, a continuous optimization process may be utilized to substantially minimize the number of actuators 515, 517, and 519 used to produce target posture or postures 513. That is to say, posture guided design engine 112 may be configured to substantially minimize the number of actuators 515, 517, 519 used to produce target posture or postures 513, and/or to determine substantially optimized locations 525, 527, and 529 for producing target posture or postures 513 using actuators 515, 517, and 519.

Flowchart 400 continues with modeling deformable object 511 using at least one material so as to substantially reproduce the target posture (430). Deformable object 511 may be modeled using two or more materials, for example, including one or more relatively easily deformable material and one or more relatively deformation resistant material, by posture guided design engine 112 using materials database 118. Alternatively, deformable object 511 can be modeled using a combination of relatively easily deformable materials, or using a combination of relatively deformation resistant materials. The relatively easily deformable material and/or the relatively deformation resistant material may be selected from materials database 118 by posture guided design engine 112 from among a variety of materials including silicone and printable plastics, for example.

In implementations in which two or more materials are used to model deformable object 511, flowchart 400 may conclude with determining a distribution of the relatively easily deformable material and the relatively deformation resistant material so as to enable deformable object 511 to substantially reproduce target posture or postures 513 (440). Referring to frame 540, in FIG. 5, frame 540 shows a distribution of first material 542, which may be a relatively easily deformable material, and second material 544, which may be a relatively deformation resistant material, as well as the substantial reproduction of visible target posture 513 by deformable object 511.

Determination of a material distribution enabling reproduction of target posture 513, effectively a substantially optimized material distribution, results in production of a posture guided design of deformable object 511, corresponding to posture guided design 214a, in FIG. 2. Determination of such a substantially optimized material distribution may be performed by posture guided design engine 112 computationally, using a continuous optimization process, for example. In some implementations, the computational process used by posture guided design engine 112 to substantially optimize the material distribution may be performed on an initially random distribution of first material 542 and second material 544 in deformable object 511.

It is noted that although the present exemplary method distinguishes between two or more materials used to model deformable object 511 in terms of their deformation characteristics, in other implementations, other distinctions between the materials selected for modeling of deformable object 511 may be used. Thus, more generally, the present approach may utilize materials, for example a first material and a second material, having different material properties. It is further noted that in some implementations, the present method may include providing materials database 118 including the material(s) used to model deformable object 511, e.g., the relatively easily deformable material and/or the relatively deformation resistant material.

It is further noted that although the method of flowchart 400 includes determining locations of actuators for producing the target posture (420) and determining a substantially optimized distribution of materials for reproducing the target posture (440), that combination is merely exemplary. For example, in some implementations, a method for use by a design system to produce a posture guided design of a deformable object may include determining locations of actuators for producing the target posture (420), but conclude with modeling the deformable object using one or more materials to substantially reproduce the target posture (430) without optimizing or otherwise determining material distribution. In other implementations, the locations of the actuators may be given or otherwise predetermined such that determination of the actuator locations (420) need not be performed, but the method may use multiple materials and include determination of a distribution of the materials for substantially reproducing the target posture (440).

Moreover, although not shown by flowchart 400, some implementations of the present method may include sending posture guided design 214a of deformable object 511 to fabrication system 222/122 for fabrication. As shown by FIG. 2, posture guided design 214a may be produced by posture guided design engine 212, and may be sent or transmitted to fabrication system 222 over communication link 207, to reside in memory 226 of fabrication system 222 as posture guided design 214b. However, as noted above, in some implementations, design system 102/202 may include fabrication system 122/222. In those implementations, the method outlined by flowchart 400 may further include fabricating deformable object 511 using posture guided design 214b, as shown by frame 550 in FIG. 5. For example, deformable object 511 may be 3D printed using a multi-material 3D printer implemented as part of fabrication system 122/222.

Thus, the present application discloses an improved design solution that adopts a posture guided design approach to design deformable objects capable of movement through transitions from one target posture to another. As described above, the present solution may be substantially automated through use of a posture guided design engine.

As a result, some implementations advantageously enable a non-expert user, such as a lay person or consumer, to design deformable objects capable of a wide range of movements.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A method for use by a design system to produce a posture guided design of a deformable object, the method comprising:
identifying a target posture for the deformable object;
determining a location of each of a plurality of actuators for producing the target posture;
modeling the deformable object using at least one material so as to enable the deformable object to substantially reproduce the target posture.

2. The method of claim 1, further comprising providing an actuator database including the plurality of actuators.

3. The method of claim 1, wherein the plurality of actuators comprise at least one of pin actuators and string actuators.

4. The method of claim 1, further comprising providing a materials database including the at least one material.

5. The method of claim 1, wherein modeling the deformable object includes using at least two materials, and wherein a distribution of the at least two materials is determined so as to enable the deformable object to substantially reproduce the target posture.

6. The method of claim 5, wherein at least one of the at least two materials comprises an easily deformable material and another at least one of the at least two materials comprises a deformation resistant material.

7. A method for use by a design system to produce a posture guided design of a deformable object, the method comprising:
identifying a target posture for the deformable object;
modeling the deformable object using at least two materials, wherein a distribution of the at least two materials is determined so as to enable the deformable object to substantially reproduce the target posture.

8. The method of claim 7, further comprising providing a materials database including the at least two materials.

9. The method of claim 7, wherein at least one of the at least two materials comprises an easily deformable material and another at least one of the at least two materials comprises a deformation resistant material.

10. The method of claim 7, further comprising determining a location of each of a plurality of actuators for producing the target posture.

11. The method of claim 10, further comprising providing an actuator database including the plurality of actuators.

12. The method of claim 10, wherein the plurality of actuators comprise at least one of pin actuators and string actuators.

13. A design system configured to produce a posture guided design of a deformable object, the design system comprising:
a system processor and a system memory;
a posture guided design engine stored in the system memory, the posture guided design engine, under control of the system processor, configured to:
identify a target posture for the deformable object;
determine a location of each of a plurality of actuators for producing the target posture;
model the deformable object using at least one material so as to enable the deformable object to substantially reproduce the target posture.

14. The design system of claim 13, further comprising an actuator database including the plurality of actuators.

15. The design system of claim 13, wherein the plurality of actuators comprise at least one of pin actuators and string actuators.

16. The design system of claim 13, further comprising a materials database including the at least one material.

17. The design system of claim 13, wherein the posture guided design engine is further configured to model the deformable object using at least two materials, wherein a distribution of the at least two materials is determined by the posture guided design engine so as to enable the deformable object to substantially reproduce the target posture.

18. The design system of claim 17, wherein at least one of the at least two materials comprises an easily deformable material and another at least one of the at least two materials comprises a deformation resistant material.

19. The design system of claim 13, further comprising a fabrication system for fabricating the deformable object based on the posture guided design.

20. The design system of claim 13, further comprising a three-dimensional (3D) printer for fabricating the deformable object based on the posture guided design.
